(19) United States
(12) Patent Application Publication
(10) Pub. No.: US 2020/0324724 A1
(43) Pub. Date: Oct. 15, 2020

(54) Safety Device for a Vehicle

(71) Applicant: Robert Bosch GmbH, Stuttgart (DE)

(72) Inventor: Marlon Ramon Ewert, Untergruppenbach (DE)

(21) Appl. No.: 16/305,413

(22) PCT Filed: May 17, 2017
(86) PCT No.: PCT/EP2017/061809

§ 371 Date: Nov. 29, 2018

(30) Foreign Application Priority Data
Jun. 2, 2016 (DE) 10 2016 209 667.2

(51) Int. Cl. B60R 21/015

(52) U.S. Cl. CPC B60R 21/01538; B60N 2/002; B60R 21/01536

(57) ABSTRACT

A safety device is for a vehicle having a plurality of vehicle seats in an interior space arranged on at least two rows of seats, and a plurality of sensor modules that are arranged/can be arranged in the interior of the vehicle to detect a seat occupancy of the vehicle seats. The safety device includes at least one sensor module operating in a contact-free manner assigned to each row of seats. The sensor modules are arranged from an inner wall of the vehicle facing the interior space in order to detect the seat occupancy of the vehicle seats.

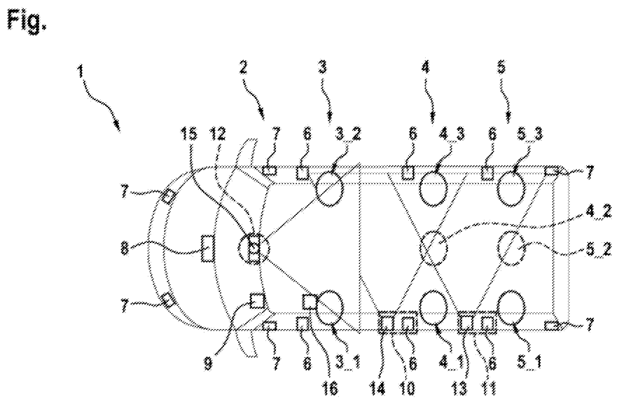

The invention relates to a safety device for a vehicle having multiple vehicle seats arranged in an interior in at least two seat rows, having multiple sensor modules, which are arranged/arrangeable to register a seat occupancy of the vehicle seats in the interior of the vehicle.

### PRIOR ART

Providing safety devices in vehicles to enhance the protection of the vehicle occupants or also of pedestrians is widespread. Systems are known for detecting pedestrian accidents, which have two or more acceleration sensors and/or comprise a pressure-hose-based system. These systems are arranged, for example, in a bumper of the vehicle, to register the collision of the vehicle with an object from the surroundings of the vehicle. Pressure sensors or acceleration sensors, which are arranged on the B, C, or D column of the vehicle, in particular as an acceleration sensor, or in the vehicle door, in particular as a pressure sensor, are presently used for registering collisions on a vehicle longitudinal side. Acceleration sensors, which are located, for example, in the central control unit and/or along a flexible crossmember of the vehicle, are presently used for recognizing collisions with objects in the front region. The signals output by the sensors are further processed by algorithms of a control unit, in particular an airbag control unit, to decide about the triggering of restraint means of the vehicle, for example, airbag units, belt tensioners, or the like.

Furthermore, carrying out an occupant recognition, for which purpose sensor modules are generally installed in the vehicle seats, which recognize the seat occupancy with the aid of a mass estimation, for example, is known. It is also recognized via belt buckle sensors whether a vehicle occupant is belted in or is not belted in during travel. The goal of occupant recognition in this case is the targeted and/or selective triggering of restraint systems of the vehicle in the event of an accident, such that the vehicle occupants are optimally protected during the accident. Thus, for example, a passenger airbag should not be triggered if a small child in a child seat is located on the passenger seat of the vehicle. For this purpose it is necessary, however, to reliably recognize the small child on the passenger seat.

A safety device having a plurality of load sensors, which are each arranged in the vehicle seat, is already known from published application DE 103 45 558 A1. Patent specification DE 10 2008 044 903 B4 also already discloses a safety device, in which sensor modules, which register the seat occupancy, are arranged in the vehicle seat.

### SUMMARY OF THE INVENTION

The safety device according to the invention having the features of claim 1 has the advantage that a seat occupancy of all vehicle seats is reliably ensured in a simple manner. In particular, the safety device according to the invention enables a cost-effective registration of the seat occupancy in comparison to known safety devices. It is provided for this purpose according to the invention that at least one contactlessly operating sensor module is associated with each seat row, wherein the sensor modules are arranged on an inner wall of the vehicle facing toward the interior in order to register the seat occupancy of the vehicle seats. The seat occupancy is thus ascertained contactlessly, and therefore costly sensors in the vehicle seats themselves can be omitted. The contactless registration of the seat occupancy moreover enables, for example, by way of image analysis, the type of the seat occupancy to be established. In particular, it can be ascertained by the contactless seat occupancy registration whether the person located on the respective vehicle seat is a small child or an adult. The restraint means of the vehicle and/or the safety device can then be activated optimally to ensure the best possible protection for the vehicle occupants.

According to one preferred refinement of the invention, it is provided that at least two sensor modules, which are arranged on opposing inner walls of the vehicle, are associated with each seat row. Each seat row is thus registered from two sides in order to ascertain the seat occupancy of the vehicle seats. A three-dimensional registration of the seat row occupancy is possible in particular in this way, by which the ascertainment of the type of the seat occupancy is also simplified. The inner walls on which the sensor modules are respectively arranged are formed in particular by the side walls, by the A, D, C, or D column, and/or by doors of the vehicle.

The sensor modules preferably each have at least one radar, laser, ultrasound, or camera sensor. In this case, the sensor modules can also be equipped with different sensors, and therefore one sensor module has, for example, a radar sensor and another sensor module, which is associated with the same seat row in particular, has a laser or camera sensor. The seat occupancy registration is possible in a cost-effective manner by means of the mentioned sensors. In this case, the requirements for the respective sensors are not as high, for example, as those on sensors which are used to register the surroundings of the motor vehicle, for example, in systems for distance warning in relation to objects traveling ahead. Therefore, more cost-effective radar, laser, or camera sensors can also be used for monitoring the interior, which occupy less installation space and are therefore easily integratable into the respective sensor module.

It is particularly preferably provided that the sensor modules are designed as airbag sensor modules or are each formed integrated into an airbag unit. The sensor modules therefore in particular also have means for registering an impact or a collision with an object in the surroundings of the vehicle. Such airbag sensor modules have become used in the meantime in any case in vehicles, as already mentioned at the outset. The airbag sensor modules are cost-effectively expandable with the desired function by the refinement to form the sensor modules, as described above, by means of the use of cost-effective radar, laser, ultrasound, or camera sensors for monitoring the interior of the vehicle. Since the sensor modules do not occupy any particular installation space, they are thus also easily integratable into the existing airbag sensor modules. It is important that the sensor modules face toward the interior of the vehicle to be able to register it. This means that the sensor of the sensor module for the seat occupancy registration faces toward the interior, while the sensor of the airbag sensor module for collision monitoring is associated in particular with the outer wall of the vehicle.

Furthermore, it is preferably provided that the sensor modules each have at least one impact sensor, in particular an acceleration sensor or pressure sensor, as means for collision registration. Therefore, each sensor module has an impact sensor and a sensor for determining the seat occupancy. The sensor module is thus expanded to form the airbag sensor module by providing the sensor and the impact sensor.

Furthermore, it is preferably provided that a movement device is associated with at least one of the vehicle seats, which is designed to move the vehicle seat into a protective position upon registration of an impact with an object in dependence on the registered seat occupancy. Although autonomously driving vehicles are not yet permitted and available on the market, nonetheless, the present development indicates that in future autonomously driving vehicles will be offered and will move on the roads. These have the advantage that the occupant previously responsible as the driver no longer has to exert a monitoring function and therefore may also turn away from the dashboard for a longer time, for example. In this way, new demands have to be satisfied by the vehicle producer, for example, the variable alignment of the vehicle seats, for example, such that the driver seat can be pivoted by 180°, and therefore the driver can converse better with further occupants of the vehicle. However, this variability has the disadvantage that the previous restraint means cannot readily be used further. In particular airbag units, which are integrated into the vehicle wall, then have to be able to adapt themselves to the new seat position of the driver, or correspondingly many airbag units have to be kept ready in order to offer optimum safety for the occupants in the event of a collision in every position of the vehicle seat. It is provided by the advantageous movement device that the vehicle seat itself is moved in order to displace the person located on the vehicle seat into an optimum or optimized position for the triggering of the restraint means in case of a collision. Thus, for example, a person located on the vehicle seat can be moved before the collision into a position in which the restraint means can act optimally on the person. This is advantageous in particular if a surroundings sensor system of the motor vehicle can predict a collision with an object in the surroundings.

Furthermore, it is preferably provided that at least one further sensor module is arranged on a roof lining or on a central tunnel of the vehicle facing toward the interior. The monitoring of the interior is improved by the further sensor module and in particular the accuracy of the person registration is enhanced.

Furthermore, it is preferably provided that at least one control unit is provided, which is especially designed for the purpose of analyzing the data provided by the sensor modules to establish the seat occupancy and to activate the movement device in dependence on the analysis. The control unit therefore ascertains the seat occupancy on the basis of the data provided by the sensor modules and activates the restraint means and in particular the movement device in case of an imminent or occurring collision in dependence on the analysis, as already described above.

The invention will be explained in greater detail hereafter on the basis of the drawing. In the single FIGURE,

the FIGURE shows a vehicle having an advantageous safety device in a simplified top view.

The FIGURE shows a simplified top view of a vehicle 1, which has an advantageous safety device 2. The vehicle is designed as a motor vehicle, which has three seat rows 3, 4, 5, wherein the first seat row 3 located in front in forward travel has two vehicle seats 3_1 and 3_2, and the seat rows 4 and 5 located behind it each have three vehicle seats 4_1 to 4_3 and 5_1 to 5_3, respectively. Airbag units 6 are associated with each of the outer vehicle seats 3_1, 3_3, 4_1, 4_3, and 5_1 and 5_3, which can be triggered in case of a collision of the motor vehicle to protect the vehicle occupants from injuries. The arrangement and position of the airbag units 6 is solely shown by way of example in the FIGURE in the present case. The airbag units 6 are expediently each arranged in a side wall of the vehicle 1, however, to protect the occupants as side airbags.

The safety device 2 advantageously has still further restraint means for protecting the vehicle occupants, for example, belt tensioners, in particular also on the middle seats 4_2 and 5_2, which further enhance the protection for the vehicle occupants.

The safety device 2 furthermore has impact sensors 7 and/or collision sensors, which are arranged, for example, on a vehicle long side or in the bumper of the vehicle 1, to be able to register a collision of the vehicle 1 with an object in the surroundings. For this purpose, the impact sensors 7 are associated with the outer side of the vehicle 1. The impact sensors 7 can be acceleration sensors, which are arranged in particular in the B, C, or D column of the vehicle, or pressure sensors, which are arranged in one or more vehicle doors of the vehicle 1. The impact sensors 7 integrated into the bumpers 7 are designed in particular as acceleration sensors or pressure-hose-based sensors, which register a collision with pedestrians.

Furthermore, the safety device 1 has a surroundings sensor system 8, which optically registers the surroundings of the motor vehicle in particular, in order to register imminent collisions even before the collision occurs.

A control unit 9 analyzes the data of the impact sensors 7 and the surroundings sensor system 8, to decide about the triggering of the restraint means located in the vehicle 1, in particular the airbag units 6 and the belt tensioners mentioned.

The safety device 2 furthermore has multiple sensor modules 10, 11, and 12, of which the sensor modules 10 and 11 are arranged on an inner wall of the vehicle 1, facing toward the interior of the vehicle 1. In this case, the sensor module 10 is associated with the seat row 4 and the sensor module 11 is associated with the seat row 5. The further sensor module 12 is arranged on the roof lining in the middle in the front region of the interior and is aligned in the direction of the front seat row 3.

Each sensor module 10, 11, 12 has a contactlessly operating sensor 13, 14, or 15, respectively, which is designed in particular as a radar sensor, ultrasound sensor, camera sensor, or laser sensor and scans the interior of the vehicle 1. The sensors 13 and 14 are each arranged with one of the sensors 7 in a shared housing and form the respective sensor module 11 or 10, respectively, together therewith. The sensor 15 is possibly arranged together with a camera module of the surroundings sensor system 8 in a housing and can thus also represent an integrated sensor. The sensor modules and 11 in particular represent airbag sensor modules, which are expanded with the function of the additional sensor 13 or 14, respectively.

The sensor modules 10, 11, 12 are therefore used, on the one hand, for collision monitoring and, on the other hand, for monitoring the interior and in particular for registering the seat occupancy of the vehicle seat rows 3, 4, and 5. The number, position, and attitude of the vehicle occupants in the interior of the vehicle 1 are ascertained by means of the respective sensors 13, 14, and 15. The sensors mentioned here are in particular not full-featured radar, ultrasound, laser, or camera sensors, as are used, for example, for a vehicle-to-vehicle distance regulation, but rather miniaturized embodiments thereof, which are suitable for integration into the peripheral airbag sensor modules 10, 11, 12. The sensors require only a short sensor range of a few meters, since they only have to register the interior of the vehicle, and therefore they can be dimensioned correspondingly small. The occupant registration preferably takes place in a two-dimensional or three-dimensional manner by means of the sensor modules 10, 11, and 12. In a second step, a determination of the present position of the occupants and the attitudes thereof is performed by the control unit 9 from the occupant registration and/or the registration of the seat occupancy.

The advantage results in this way that the seat occupancy can be carried out even more reliably and accurately than previously. Restraint means of the vehicle 1, for example, airbag units or belt tensioners, can be triggered in an even more targeted manner in this way, whereby the safety in road traffic is enhanced for the occupants of the vehicle 1.

If the vehicle 1 is additionally designed as an autonomous or partially autonomous vehicle, which can thus cover a predetermined route autonomously or partially autonomously, for example, at least one of the vehicle seats 3_1 to 5_3 has a movement device 16, shown by way of example in the FIGURE for the driver seat, which can adjust the driver seat from a driver position into a passenger position pivoted by 180°. The movement device 16 is preferably activatable by the control unit 9, in order to displace the driver seat 3_1 in a short time in case of an imminent collision into a position in which the person located on the driver seat is thus protected as well as possible. The accurate knowledge and attitude of the position at the time of travel is therefore very advantageous. The position may be registered by means of the advantageous safety device 2 and may be adapted in a timely manner if needed by means of the movement device 16. In addition, for example, a plausibility check of an occupant registration unit optionally installed in the vehicle 1, which has occupancy sensors in the vehicle seats, for example, possible by means of the safety device 2.

It is additionally possible with the aid of the advantageous safety system 2 to establish in which position and attitude the vehicle occupants are located before, during, and after an accident. The course of an accident can thus be reconstructed easily, for example, to establish why specific occupants have received specific injuries therefrom. In addition, it is possible by means of the safety device 2 to determine the attitude and position of the vehicle occupants after an accident, for example, if the last position and attitude of the occupants was stored before an accident. This is advantageous above all if the occupants are pinned into the vehicle and have to be freed by the rescue services from the vehicle. The safety device 2, in particular the control unit 9, advantageously has a wireless interface for this purpose, in particular in the manner of a vehicle-to-X communication interface, by means of which rescue services can read out the stored items of information about the attitude and position of the occupants. In addition, it is conceivable to transmit the forces which have acted on the occupants during the accident via the communication interface to the rescue services, and therefore an estimation of the injuries of the occupants can be carried out already during the approach to the accident site and if necessary required treatment measures can be prepared.

In addition, a use of the safety device 2 in government vehicles is also conceivable, in order to monitor the attitude and position of persons under arrest in particular during the transportation. With the aid of intelligent algorithms, possible escape attempts of the persons can be predictively recognized and prevented. While in the present exemplary embodiment, the sensor modules 10, 11 are arranged on only one side wall of the vehicle 1, it is provided according to a further exemplary embodiment that corresponding sensor modules are also arranged on the opposite side wall of the vehicle, facing toward the interior, to also be able to register the respective seat rows 4 and 5 from the other side, whereby the seat occupancy determination can be carried out even more accurately. It is also possible in this case to cover vehicle regions which were previously not covered by a previously provided occupant recognition. It is also conceivable to arrange a further sensor module on the central tunnel of the vehicle, for example, between the seat rows 3 and 4 or 4 and 5, the contactlessly operating sensor of which is oriented upward, in order to ascertain or plausibility-check a seat occupancy.

1. A safety device for a vehicle having multiple vehicle seats arranged in at least two seat rows, comprising:
at least one contactlessly operating sensor module located in an interior of the vehicle and configured to register a seat occupancy of the vehicle seats in the interior, at least one contactlessly operating sensor module is associated with each seat row, and the at least one contactlessly operating sensor module arranged on an inner wall of the vehicle facing toward the interior in order to register the seat occupancy of the vehicle seats.

2. The safety device as claimed in claim 1, wherein at least two contactlessly operating sensor modules are arranged on opposing inner walls of the vehicle, and are associated with each seat row.

3. The safety device as claimed in claim 1, wherein the at least one contactlessly operating sensor module includes at least one radar, laser, ultrasound, or camera sensor.

4. The safety device as claimed in claim 1, wherein the at least one contactlessly operating sensor module is configured as an airbag sensor module or is integrated into an airbag unit.

5. The safety device as claimed in claim 1, wherein the at least one contactlessly operating sensor module includes at least one impact sensor.

6. The safety device as claimed in claim 1, further comprising:
a movement device associated with at least one of the vehicle seats, the movement device configured to move the vehicle seat into a protective position upon registration of a collision of the vehicle with an object in dependence on the registered seat occupancy.

7. The safety device as claimed in claim 1, wherein at least one further contactlessly operating sensor module is arranged on a roof lining or on a central tunnel of the vehicle, facing toward the interior.

8. The safety device as claimed in claim 6, further comprising:
a restraint device; and
at least one control unit configured to analyze data provided by the at least one contactlessly operating sensor module to establish the seat occupancy and to activate the restraint device and/or the movement device in dependence on the analysis.
